(19) United States
(12) Patent Application Publication
(10) Pub. No.: US 2025/0316098 A1
(43) Pub. Date: Oct. 9, 2025

(54) METHOD OF CALIBRATING A MICROSCOPE SYSTEM

(71) Applicant: SYNCELL (TAIWAN) INC., Taipei City (TW)

(72) Inventors: Jung-Chi LIAO, Taipei City (TW); Yi-De CHEN, Taipei (TW)

(21) Appl. No.: 18/864,997

(22) PCT Filed: May 12, 2023
(86) PCT No.: PCT/US2023/066946

§ 371 Date: Nov. 12, 2024

Related U.S. Application Data
(60) Provisional application No. 63/341,256, filed on May 12, 2022.

(51) Int. Cl. G06V 20/69; G02B 21/36; G06V 10/141; G06V 10/145; G06V 10/98

(52) U.S. Cl. CPC G06V 20/693; G02B 21/365; G06V 10/141; G06V 10/145; G06V 10/993; G06V 20/698

(57) ABSTRACT

A microscope based system for image-guided microscopic illumination is provided. The system may include a microscope, a stage, an imaging subsystem adapted to obtain an image of a sample on the stage, a processing subsystem adapted to identify regions of interest in the sample from images obtained by the imaging subsystem, and a pattern illumination subsystem adapted to illuminate the regions of interest based on coordinates derived from the images by the processing subsystem. Methods of calibrating the microscope based system may include projecting light from the pattern illumination subsystem onto the sample in the illumination pattern based on computed coordinates of the desired pattern, obtaining an image of the illumination pattern from the sample with the imaging subsystem, measuring differences between actual coordinates of the illumination pattern in the image and the computed coordinates, ‘and generating correction factors based on the measured differences to calibrate the system automatically.

### CLAIM OF PRIORITY

This application claims priority to U.S. Provisional Patent Application No. 63/341,256 filed on May 12, 2022, titled “METHOD OF CALIBRATING A MICROSCOPE SYSTEM,” which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

### Technical Field

The present disclosure relates to a system and method for illuminating patterns on a sample, especially relating to a microscope-based system and method for illuminating varying patterns through a large number of fields of view consecutively at a high speed. The present disclosure also relates to systems and methods for calibrating a microscope-based system.

### Related Arts

There are needs in illuminating patterns on samples (e.g., biological samples) at specific locations. Processes such as photobleaching of molecules at certain subcellular areas, photoactivation of fluorophores at a confined location, optogenetics, light-triggered release of reactive oxygen species within a designated organelle, or photoinduced labeling of biomolecules in a defined structure feature of a cell all require pattern illumination. For certain applications, the pattern of the abovementioned processes may need to be determined by a microscopic image. Some applications further need to process sufficient samples, adding the high-content requirement to repeat the processes in multiple regions. Systems capable of performing such automated image-based localized photo-triggered processes are rare.

One example of processing proteins, lipids, or nucleic acids is to label them for isolation and identification. The labeled proteins, lipids, or nucleic acids can be isolated and identified using other systems such as a mass spectrometer or a sequencer.

Complicated microscope-based systems can include a number of subsystems, including illumination subsystems and imaging subsystems. Long term drift of the machatronis between the various subsystems of a microscope-based system can result in a mismatch between imaging samples, detecting the patterns of the desired location on the samples, and the result of pattern illumination on the samples. There is a need for calibration techniques to ensure that microscope-based systems are able to accurately pattern illuminate microscope samples in long term. An automatic calibration method that can monitor the daily accuracy and calibrated the system by analyzing statistics data is further required to reduce the frequency of the manual calibration and make the system more reliable and friendly to the end users.

### SUMMARY

In view of the foregoing objectives, this disclosure provides image-guided systems and methods to enable illuminating varying patterns on the sample and calibration of the image-guided systems to ensure accurate illumination of patterns on the sample in the long term.

A method of calibrating a microscope system is provided, the microscope system comprising a stage, an imaging subsystem adapted to obtain one or more images of a sample on the stage, a processing subsystem adapted to identify a region of interest in the sample from images obtained by the imaging subsystem, and a pattern illumination subsystem adapted to illuminate the region of interest in an illumination pattern based on computed coordinates of a desired pattern derived from the images by the processing subsystem, the method comprising: projecting light from the pattern illumination subsystem onto the sample in the illumination pattern based on computed coordinates of the desired pattern; obtaining an image of the illumination pattern from the sample with the imaging subsystem; measuring differences between actual coordinates of the illumination pattern in the image and the computed coordinates; and generating correction factors based on the measured differences.

In some aspects, the step of obtaining an image comprises obtaining a fluorescent image of the sample. In other aspects, the step of obtaining an image comprises obtaining an image of photobleaching.

In one aspect, the sample comprises a sample slide, the step of obtaining an image comprising obtaining an image of a reflection of the illumination pattern from the sample slide.

In another aspect, the method includes storing the correction factors.

In some aspects, the method comprises using the correction factors to calibrate the pattern illumination subsystem to adjust a position of light projected by the pattern illumination subsystem.

In one aspect, the step of using the correction factors to adjust a position of light projected by the pattern illumination subsystem is performed only if the correction factors exceed a predetermined calibration threshold.

In some aspects, the pattern illumination subsystem comprises a movable element. In one aspect, the pattern illumination subsystem comprises a digital micro-mirror device.

In one aspect, the step of using the correction factors to adjust a position of light projected by the pattern illumination subsystem comprises adjusting movement of the movable element.

In other aspects, the projecting step comprising moving the movable element to project light from the pattern illumination system sequentially from a first coordinate to a second coordinate and from the first coordinate to a third coordinate, a distance between the first coordinate and the second coordinate being different than a distance between the first coordinate and the third coordinate.

In one aspect, the movable element comprises a movable mirror.

In other aspects, the pattern illumination subsystem comprises a spatial light modulator.

In one aspect, the step of obtaining an image comprises obtaining an image of quenching.

A microscope system is provided, comprising: a stage; a sample disposed on the stage; an imaging subsystem adapted to obtain one or more images of the sample; a processing subsystem adapted to identify regions of interest in the sample from images obtained by the imaging subsystem; and a pattern illumination subsystem adapted to illuminate the regions of interest based on coordinates derived from the images by the processing subsystem, the pattern illumination subsystem being configured to: project light from the pattern illumination subsystem onto the sample in the illumination pattern based on computed coordinates of the desired pattern; obtain an image of the illumination pattern from the sample with the imaging subsystem; measure differences between actual coordinates of the illumination pattern in the image and the computed coordinates; and generate correction factors based on the measured differences.

In some aspects, the image comprises a fluorescent image of the sample. In another aspect, the image comprises a photobleaching image. In one aspect, the image comprises a quenching image.

In some embodiments, the sample comprises a sample slide, wherein the image is of a reflection of the illumination pattern from the sample slide.

In one aspect, the system further includes memory configured to store the correction factors.

In one aspect, the pattern illumination subsystem is configured to use the correction factors to calibrate the pattern illumination subsystem to adjust a position of light projected by the pattern illumination subsystem.

In other aspects, the pattern illumination subsystem is configured to use the correction factors to adjust a position of light projected by the pattern illumination subsystem only if the correction factors exceed a predetermined calibration threshold.

In one aspect, the pattern illumination subsystem comprises a movable element.

In some aspects, the pattern illumination subsystem comprises a digital micro-mirror device.

In one aspect, the pattern illumination subsystem is configured to use the correction factors to adjust a position of light projected by the pattern illumination subsystem by controlling movement of the movable element.

In some aspects, the pattern illumination subsystem is configured to move the movable element to project light from the pattern illumination system sequentially from a first coordinate to a second coordinate and from the first coordinate to a third coordinate, a distance between the first coordinate and the second coordinate being different than a distance between the first coordinate and the third coordinate.

In one aspect, the movable element comprises a movable mirror.

In some aspects, the pattern illumination subsystem comprises a spatial light modulator.

A non-transitory computing device readable medium is provided, the medium having instructions stored thereon, wherein the instructions are executable by one or more processors to cause a computing device to perform a method comprising: obtain an image of an illumination pattern projected on a microscope sample with an imaging subsystem; measure differences between actual coordinates of the illumination pattern in the image and computed coordinates of a desired pattern; and generate correction factors based on the measured differences.

In some aspects, the image comprises a fluorescent image of the microscope sample.

In other aspects, the image comprises a photobleaching image of the microscope sample.

In some aspects, the microscope sample comprises a sample slide, wherein the instructions are executable by the one or more processors to cause the computing device to obtain an image of a reflection of the illumination pattern from the sample slide.

In one aspect, the instructions are executable by the one or more processors to cause the computing device to use the correction factors to calibrate the pattern illumination subsystem to adjust a position of light projected by the pattern illumination subsystem.

In one aspect, the instructions are executable by the one or more processors to cause the computing device to use the correction factors to adjust a position of light projected by the pattern illumination subsystem only if the correction factors exceed a predetermined calibration threshold.

In another aspect, the instructions are executable by the one or more processors to cause the computing device to use the correction factors to adjust a position of light projected by the pattern illumination subsystem by controlling movement of a movable element.

In some aspects, the instructions are executable by the one or more processors to cause the computing device to move a movable element to project light from the pattern illumination system sequentially from a first coordinate to a second coordinate and from the first coordinate to a third coordinate, a distance between the first coordinate and the second coordinate being different than a distance between the first coordinate and the third coordinate.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 shows one embodiment of a microscope-based system for image-guided microscopic illumination.

FIG. 2A shows a field of view in which the system's imaging and processing subsystems may identify a subcellular region of interest in a cell.

FIG. 2B shows a magnified view of the subcellular region of interest in the cell.

FIGS. 3A and 3B show light from a pattern illumination subsystem moving through regions of interest in a vector pattern and a raster pattern, respectively.

FIGS. 4A and 4B show how a misalignment may result in a vector scan path t.

FIG. 5A shows an imaging subsystems acquiring an image in a first field of view of a sample.

FIG. 5B shows the results of a pattern illumination in a sample.

FIG. 5C shows an image of a second field of view of the sample as acquired by the system.

FIG. 5D shows coordinates of regions of interest being illuminated by a processing module to create dark regions.

FIG. 5E shows an image of a third field of view of the sample as acquired.

FIG. 5F shows coordinates of regions of interest being illuminated by a processing module to create dark regions and the reflected illumination pattern as a real-time pattern illumination image

FIG. 5G shows an image of a subsequent field of view acquired by the system and the regions of interest identified by the system's processing module.

FIG. 5H shows the calibrated results of a pattern illumination in a sample.

FIG. 6 is a chart showing that each pattern illumination is analyzed in multiple fields of view and automatic calibrated in a certain condition.

### DETAILED DESCRIPTION

US Patent Publ. No. 2018/0367717 describes multiple embodiments of a microscope-based system for image-guided microscopic illumination. In each embodiment, the system employs an imaging subsystem to illuminate and acquire an image of a sample on a slide, a processing module to identify the coordinates of regions of interest in the sample, and a pattern illumination subsystem to use the identified coordinates to illuminate the regions of interest using, e.g., photo illumination to photoactivate the regions of interest. Any misalignment between the imaging subsystem and the pattern illumination subsystem may result in a failure to successfully photoactivate the regions of interest. In addition, any optical aberrations in either system must be identified and corrected for.

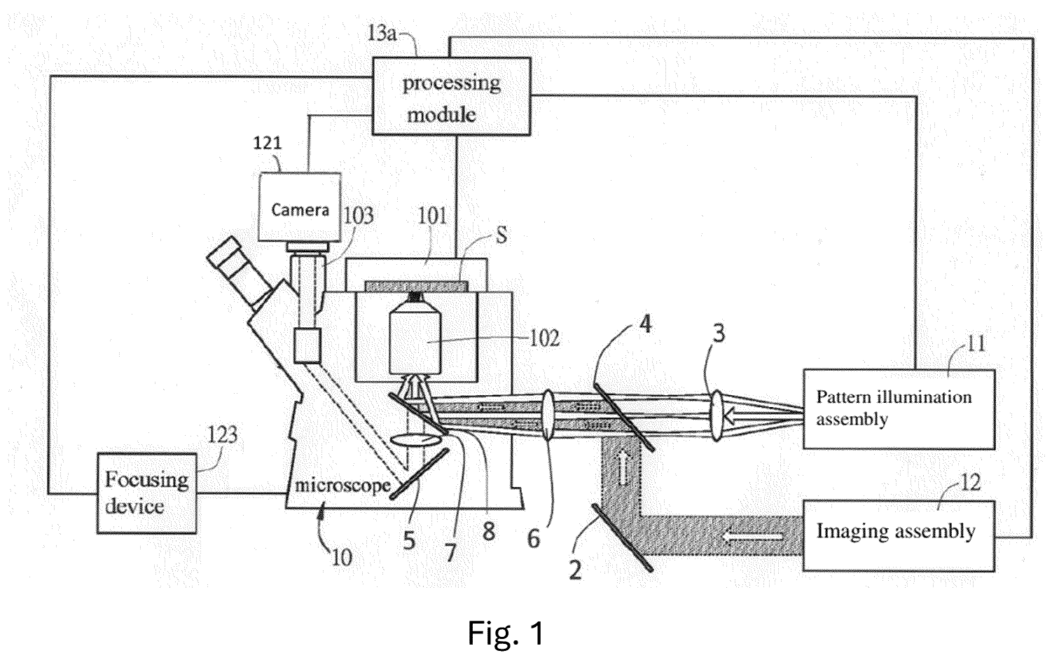

This disclosure provides a calibration method for a microscope-based system having two sample illumination subsystems, one for capturing images of the sample in multiple fields of view and another for illuminating regions of interest in each field of view that were automatically identified in the images based on predefined criteria. FIG. 1 shows one embodiment of a microscope-based system for image-guided microscopic illumination. Other details may be found in US Publ. No. 2018/0367717. A microscope 10 has an objective 102, a subjective 103, and a stage 101 loaded with a calibration sample S. An imaging assembly 12 can illuminate the sample S via mirror 2, mirror 4, lens 6, mirror 8, and objective 102. An image of the sample S is transmitted to a camera 121 via mirror 8, lens 7, and mirror 5. The stage 101 can be moved to provide different fields of view of the sample S.

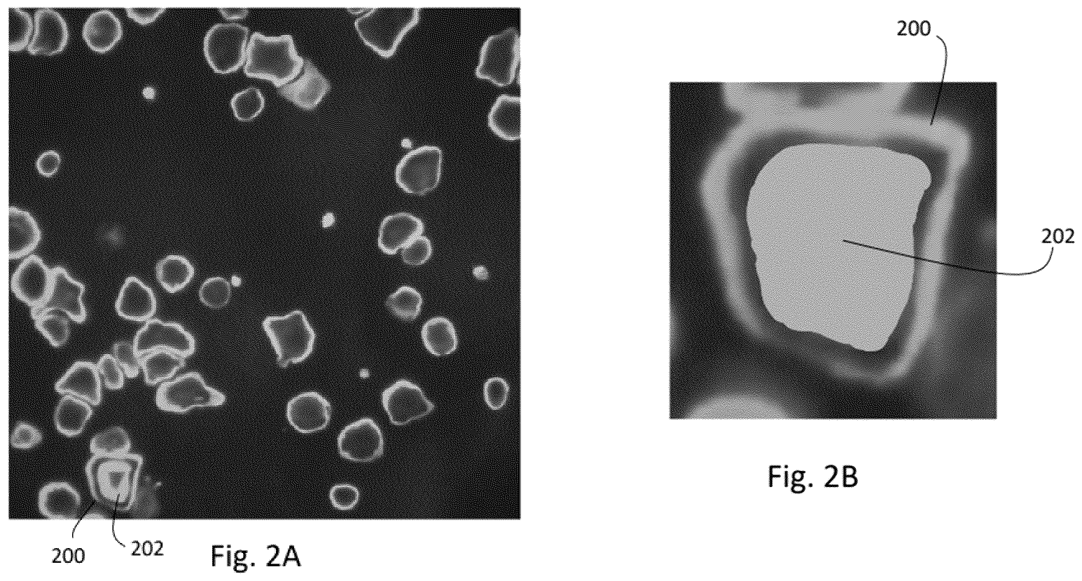

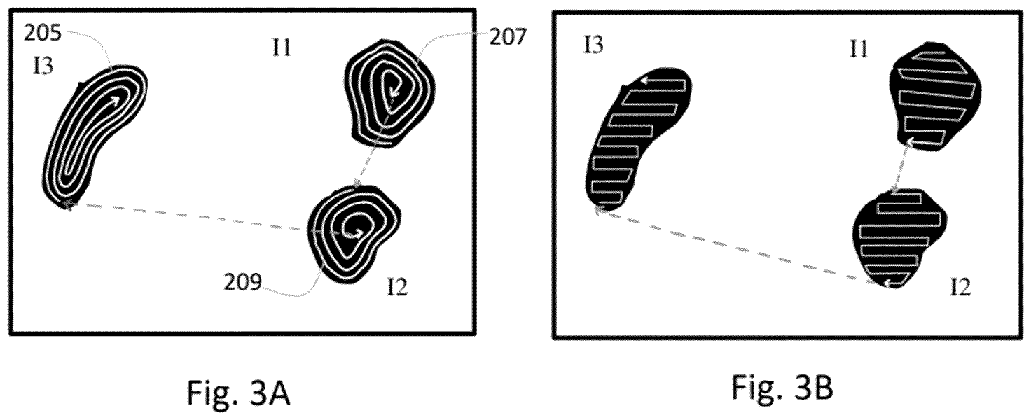

In some embodiments, as described in US Publ. No. 2018/0367717, images obtained by camera 121 can be processed in a processing module 13a to identify regions of interest in the sample. When the sample contains cells, particular subcellular areas of interest can be identified by their morphology. For example, in the field of view shown in FIG. 2A, the system's imaging and processing subsystems may identify a subcellular region of interest 202 in a cell 200, as better seen in the magnified view of FIG. 2B. In some embodiments, the regions of interest identified by the processing module from the images can thereafter be selectively illuminated with a different light source for, e.g., photobleaching of molecules at certain subcellular areas, quenching, photoactivation of fluorophores at a confined location, optogenetics, light-triggered release of reactive oxygen species within a designated organelle, or photoinduced labeling of biomolecules in a defined structure feature of a cell all require pattern illumination. The coordinates of the regions of interest identified by the processing module 13a create a pattern for such selective illumination. The embodiment of FIG. 1 therefore has a pattern illumination assembly 11 which projects onto sample S through a lens 3, mirror 4, lens 6, and mirror 8. In some embodiments, pattern illumination assembly 11 is a laser whose light is moved through the pattern of the region of interest in the sample S by a movable element within the pattern illumination assembly 11. The movable element could be, e.g., a Galvanometer or a digital micro-mirror device (DMD). In other embodiments, the light may be modulated toward the pattern of the region of interest in the sample S by a non-movable element, which could be, e.g., a Spatial Light Modulator for controlling the intensity of a light beam at a certain area. In some embodiments the light from pattern illumination assembly 11 moves sequentially through the regions of interest 11, 12, 13, in a vector pattern, as shown in FIG. 3A, and in some embodiments the light from pattern illumination assembly 11 moves through the regions of interest 11, 12, and 13 in a raster pattern, as shown in FIG. 3B.

The microscope, stage, imaging subsystem, and/or processing subsystem can include one or more processors configured to control and coordinate operation of the overall system described and illustrated herein. In some embodiments, a single processor can control operation of the entire system. In other embodiments, each subsystem may include one or more processors. The system can also include hardware such as memory to store, retrieve, and process data captured by the system. Optionally, the memory may be accessed remotely, such as via the cloud. In some embodiments, the methods or techniques described herein can be computer implemented methods. For example, the systems disclosed herein may include a non-transitory computing device readable medium having instructions stored thereon, wherein the instructions are executable by one or more processors to cause a computing device to perform any of methods described herein.

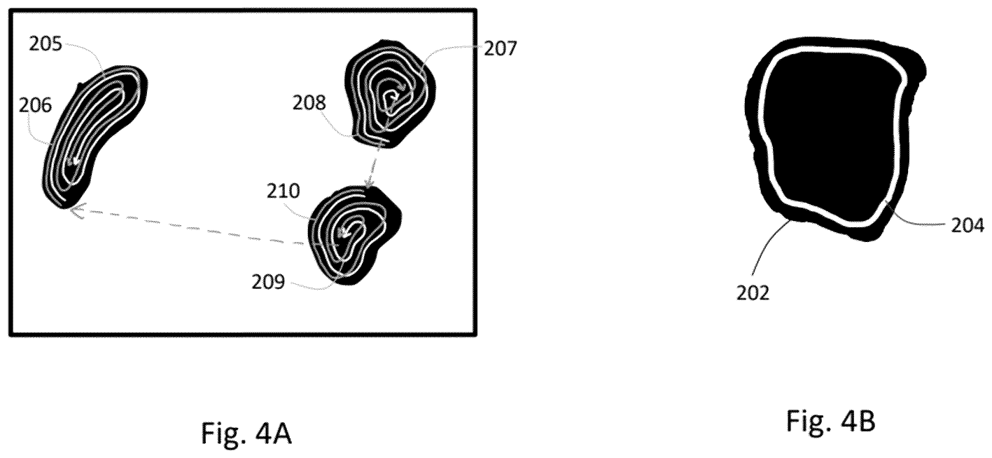

In order for the pattern illumination to illuminate the desired regions of interest, the coordinates identified from the image must result in illumination in a pattern that aligns with the coordinates. For example, misalignment may result in the vector scan paths 206, 208, and 210 shown in FIG. 4A instead of the desired scan paths 205, 207, and 209 of FIG. 3A. Thus, instead of scanning the entire region of interest 202, the scan path may result in an illumination pattern that covers a region 204 that is less than the entire region of interest 202, as shown in FIG. 4B, covers an unwanted region, or is shifted in relation to the entire region of interest 202.

In order to address misalignment of the imaging and pattern illumination structure and any aberrations introduced by the lenses and mirrors in the light path, a calibration process may be performed periodically during use of the system (e.g., daily, weekly, monthly). In one embodiment, a fluorophore is attached to the sample and is activated by the pattern illumination light. As the illumination light is projected onto the sample, the camera 121 obtains images of the resulting fluorescence. The processing subsystem compares the coordinates of the fluorescent image to the coordinates of the region of interest it had determined from the image obtained by the imaging subsystem and provided to the illumination subsystem for illumination. The differences between the desired and actual pattern illumination coordinates (which could be derived from photobleach/darkness, quenching, bright boundary, reflection or illuminating light pattern) are converted to correction factors which are stored for use in future scans to adjust the coordinates of an illumination pattern to fit the coordinates of regions of interest identified in images of the sample by, e.g., adjusting the movement of the mirror directing the pattern illumination scan.

In other embodiments, instead of obtaining a fluorescent image of the illuminated pattern, the system obtains an image of the reflection of the pattern illumination from the interface of a cover slide over the sample. Once again, the processing subsystem compares the coordinates of this reflected illumination pattern derived from pattern illumination assembly 11 to the coordinates of the region of interest it had determined from the image obtained by the imaging assembly 12 and provided to the processing module 13a. The differences between the desired and actual pattern illumination coordinates are converted to correction factors for use in future scans to adjust the coordinates of an illumination pattern to fit the coordinates of regions of interest identified in images of the sample by, e.g., adjusting the movement of the mirror directing the pattern illumination scan or by changing the projection pattern of a spatial light monitor.

In some embodiments, instead of obtaining a fluorescent image of the illuminated pattern, the system obtains an image of a photobleach area or darkness area resulting from illuminating regions of interest of the sample. Once again, the processing subsystem compares the coordinates of the photobleach area resulting from illumination by the pattern illumination assembly 11 to the coordinates of the region of interest it had determined from the image obtained by the imaging assembly 12 and provided to the processing module 13a. The differences between the desired and actual pattern illumination coordinates are converted to correction factors for use in future scans to adjust the coordinates of illumination pattern to fit the coordinates of regions of interest identified in images of the sample by, e.g., adjusting the movement of the mirror directing the pattern illumination scan.

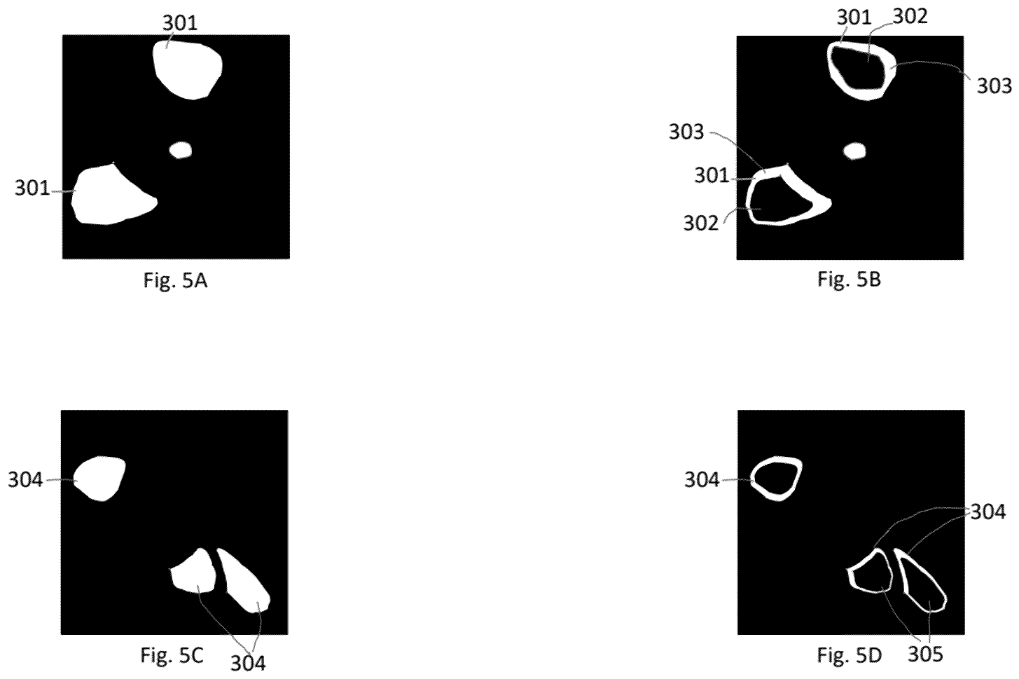

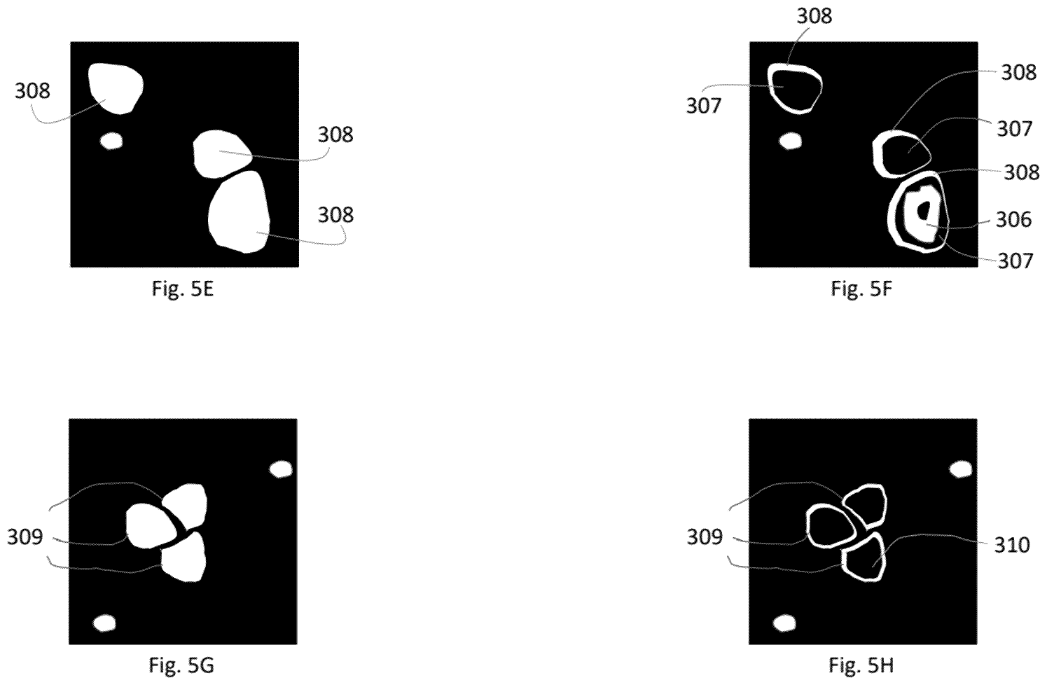

In some embodiments, after the imaging light source assembly 12 acquires an image in a first field of view of a sample as shown in FIG. 5A, the processing module 13a based on an image processing method determines coordinates for regions of interest 301, e.g., cells and nuclei. In this embodiment, the image processing is done with real-time image processing techniques such as thresholding, erosion, filtering, or artificial intelligence trained semantic segmentation methods. When the processing module 13a controls the pattern illumination assembly 11 to illuminate the regions of interest 301, the real-time illuminating images or video are recorded by a camera, such as camera 121 in FIG. 1. The results of the pattern illumination are shown in FIG. 5B, with the illuminated regions shown as dark regions 302 and the non-illuminated regions displayed as bright boundaries 303 in the real-time image. Based on the real-time image in FIG. 5B, the processing module 13a could calculate information, e.g., the area of the darkness 302, the location of the boundary 303, the completeness of the boundary 303, and the linewidth of the boundary 303. The processing module 13a could compare the illuminated coordinates from real-time image with coordinates, which was previously determined by processing module 13a for pattern illumination. The differences between coordinates of the real-time pattern illumination and prior-determined coordinates are converted to correction factors which are stored for use in future scans to adjust the coordinates of illumination pattern to fit the coordinates of regions of interest identified in images of the sample by, e.g., adjusting the movement of the mirror directing the pattern illumination scan.

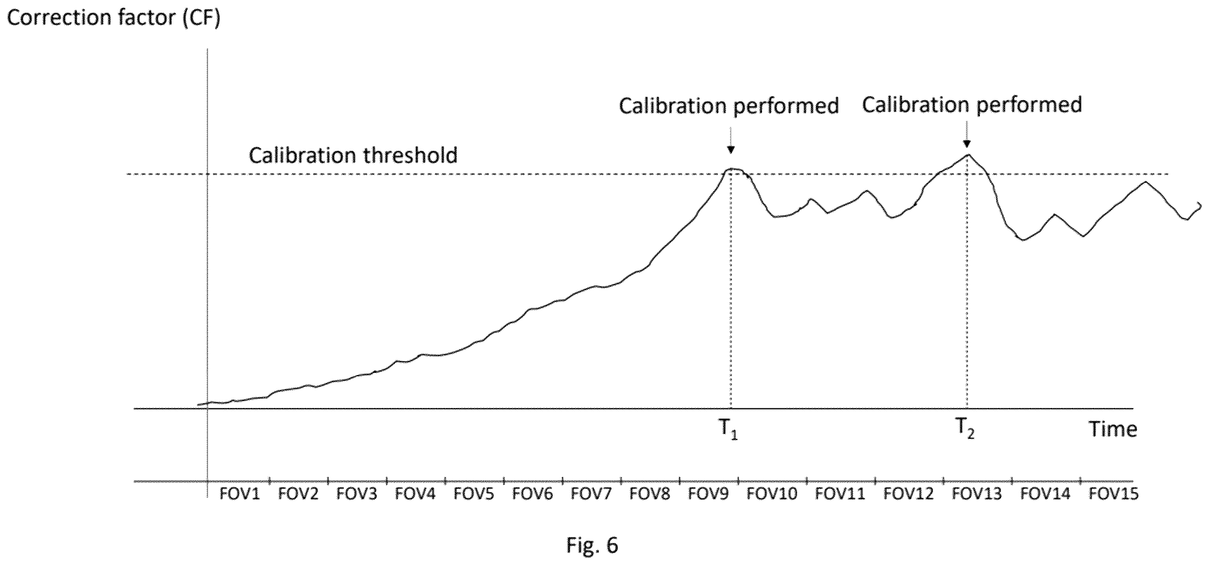

In other embodiments, the correction factors could be stored or accumulated so as to compare with a calibration threshold. Calibration for eliminating or reducing the coordinate difference between the real-time pattern-illumination image and image acquired from imaging assembly 12 can be performed only when the correction factors exceed a calibration threshold. In some embodiments, the calibration does not automatically proceed until the correction factor calculated in a field of view exceeds the calibration threshold, as shown in FIG. 6.

FIG. 5C shows an image of a second field of view of the sample as acquired by the system. After the coordinates of regions of interest 304 are determined and then illuminated by processing module 13a to create the dark regions 305, as shown in FIG. 5D, the processing module 13a could compare the image-determined coordinates of regions 304 derived from FIG. 5C with the real-time pattern illumination coordinates of the dark regions 305 detected by the camera (such as camera 121) to determine the magnitude of the shifts or other differences between regions 304 and 305 in order to compute the correction factors needed to align regions 304 and regions 305. In this case, the shift or correction factor did not exceed the calibration threshold and thus no automatic calibration was performed.

FIG. 5E shows an image of a third field of view of the sample as acquired. Once again, coordinates of regions of interest 308 are determined and then illuminated by processing module 13a to create dark regions 307, as shown in FIG. 5F. In one of the regions of interest, however, part of the illuminating light in one of the regions of interest was reflected when it reached the sample. Processing module 13a stores the reflected light pattern 306 as a real-time pattern illumination image. The processing module 13a could compare the image-determined coordinates with the coordinates of the reflected pattern 306 to determine the correction factor under this field of view. In some embodiments, the correction factor resulting from the reflected pattern 306 and the correction factor resulting from the shift of the area of darkness 307, location of the boundary of regions of interest 308, completeness of the boundary of regions of interest 308, or linewidth of the boundary of region of interest 308 could be accumulated until the accumulated correction factor(s) exceed the calibration threshold so that the automatic calibration for eliminating or reducing the coordinate difference between the real-time pattern illumination image and the image-determined coordinates, which is used for the pattern illumination.

In one embodiment as shown in FIG. 5G, automatic calibration was performed on the system using image and illumination information gathered in connection with a previous field of view. FIG. 5G shows an image of a subsequent field of view acquired by the system and the regions of interest 309 identified by the system's processing module 13a. Using coordinate information of the regions of interest 309 determined from the image by the processing module, the calibrated system then illuminates the regions of interest 309 to create dark areas 310, as shown in FIG. 5H. The borders of the dark (illuminated) regions 310 align closely with the borders of the regions of interest 309 identified from the image. The correction factor based on the coordinate difference between the regions of interest 309 identified from the image and the illuminated regions 310 is under the calibration threshold because the previous calibration eliminated or reduced the coordinate difference.

Each sample will be analyzed in multiple fields of view as shown in FIG. 6. FIG. 6 is a hypothetical plot of imaging and illuminating processes performed by the system over time and field of view (FOV) versus the correction factor computed from differences between the desired coordinates for illumination (computed from an image of the region of interest) and the actual illumination pattern for that region of interest. The correction factors computed by the system as described above were below the calibration threshold for the imaging/illuminating processes in the fields of view scanned up until time T₁ (FOV9). In other words, after a plurality of fields of view are illuminated by the system, the correction factors are accumulated enough to perform the calibration. At T₁, the computed correction factor exceeded the calibration threshold, and a calibration was automatically performed by the system. Imaging/illuminating processes in subsequent fields of view after time T₁ resulted in computed correction factors under the calibration threshold until time T₂ (FOV13), at which point the computed correction factor exceeded the threshold and calibration was performed again. Thus, by calibrating only when the correction factor calibration threshold is exceeded, and not in every field of view, the present disclosure reduces the frequency of calibration, thereby minimizing the scan time of a sample with many fields of view. In addition, by calculating correction factors and performing calibration using the sample fields of view that are being imaged, analyzed, and illuminated (e.g., for activating a photochemical reaction in the illuminated patterns of the regions of interest in each field of view), the present disclosure avoid the need for a standard device or sample for calibration.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method of calibrating a microscope system, the microscope system comprising a stage, an imaging subsystem adapted to obtain one or more images of a sample on the stage, a processing subsystem adapted to identify a region of interest in the sample from images obtained by the imaging subsystem, and a pattern illumination subsystem adapted to illuminate the region of interest in an illumination pattern based on computed coordinates of a desired pattern derived from the images by the processing subsystem, the method comprising:
projecting light from the pattern illumination subsystem onto the sample in the illumination pattern based on computed coordinates of the desired pattern;
obtaining an image of the illumination pattern from the sample with the imaging subsystem;
measuring differences between actual coordinates of the illumination pattern in the image and the computed coordinates; and
generating correction factors based on the measured differences.

2. The method of claim 1 wherein the step of obtaining an image comprises obtaining one of a fluorescent image of the sample, a photobleaching image of the sample, a quenching image of the sample, and an image of a reflection of the illumination pattern from a sample slide on the sample.

3-4. (canceled)

5. The method of claim 1 further comprising storing the correction factors.

6. The method of claim 1 further comprising using the correction factors to calibrate the pattern illumination subsystem to adjust a position of light projected by the pattern illumination subsystem.

7. The method of claim 6 wherein the step of using the correction factors to adjust a position of light projected by the pattern illumination subsystem is performed only if the correction factors exceed a predetermined calibration threshold.

8. The method of claim 6 wherein the pattern illumination subsystem comprises a movable element, and wherein using the correction factors to calibrate the pattern illumination subsystem to adjust the position of light projected by the pattern illumination subsystem further comprises adjusting movement of the movable element.

9-11. (canceled)

12. The method of claim 8, wherein the movable element comprises a Galvanometer or a digital micro-mirror device (DMD).

13-14. (canceled)

15. A microscope system, comprising:
a stage;
a sample disposed on the stage;
an imaging subsystem adapted to obtain one or more images of the sample;
a processing subsystem adapted to identify regions of interest in the sample from images obtained by the imaging subsystem; and
a pattern illumination subsystem adapted to illuminate the regions of interest based on coordinates derived from the images by the processing subsystem, the pattern illumination subsystem being configured to:
project light from the pattern illumination subsystem onto the sample in the illumination pattern based on computed coordinates of the desired pattern;
obtain an image of the illumination pattern from the sample with the imaging subsystem;
measure differences between actual coordinates of the illumination pattern in the image and the computed coordinates; and
generate correction factors based on the measured differences.

16. The microscope system of claim 15, wherein the image comprises one of a fluorescent image of the sample, a photobleaching image of the sample, a quenching image of the sample, and an image of a reflection of the illumination pattern from a sample slide on the sample.

17-19. (canceled)

20. The microscope system of claim 15, further comprising memory configured to store the correction factors.

21. The microscope system of claim 15, wherein the pattern illumination subsystem is configured to use the correction factors to calibrate the pattern illumination subsystem to adjust a position of light projected by the pattern illumination subsystem.

22. The microscope system of claim 21, wherein the pattern illumination subsystem is configured to use the correction factors to adjust a position of light projected by the pattern illumination subsystem only if the correction factors exceed a predetermined calibration threshold.

23. The microscope system of claim 15, wherein the pattern illumination subsystem comprises a movable element, and the pattern illumination subsystem is configured to use the correction factors to adjust a position of light projected by the pattern illumination subsystem by controlling movement of the movable element.

24-26. (canceled)

27. The microscope system of claim 23, wherein the movable element comprises a Galvanometer or a digital micro-mirror device (DMD).

28. (canceled)

29. A non-transitory computing device readable medium having instructions stored thereon, wherein the instructions are executable by one or more processors to cause a computing device to perform a method comprising:
obtain an image comprising an illumination pattern projected on a microscope sample by a pattern illumination subsystem with an imaging subsystem;
measure differences between actual coordinates of the illumination pattern in the image and computed coordinates of a desired pattern; and
generate correction factors based on the measured differences.

30. The non-transitory computing device readable medium of claim 29, wherein the image comprises one of a fluorescent image of the microscope sample, a photobleaching image of the microscope sample, a quenching image of the microscope sample, and an image of a reflection of the illumination pattern from a sample slide on the microscope sample.

31-32. (canceled)

33. The non-transitory computing device readable medium of claim 29, wherein the instructions are executable by the one or more processors to cause the computing device to use the correction factors to calibrate the pattern illumination subsystem to adjust a position of light projected by the pattern illumination subsystem.

34. The non-transitory computing device readable medium of claim 29, wherein the instructions are executable by the one or more processors to cause the computing device to use the correction factors to adjust a position of light projected by the pattern illumination subsystem only if the correction factors exceed a predetermined calibration threshold.

35. The non-transitory computing device readable medium of claim 29, wherein the instructions are executable by the one or more processors to cause the computing device to use the correction factors to adjust a position of light projected by the pattern illumination subsystem by controlling movement of a movable element of the pattern illumination subsystem.

36. (canceled)

37. The non-transitory computing device readable medium of claim 35, wherein the movable element comprises a Galvanometer or a digital micro-mirror device (DMD).
